(19) United States
(12) Patent Application Publication
(10) Pub. No.: US 2003/0061046 A1
(43) Pub. Date: Mar. 27, 2003

(54) Method and system for integrating long-span language model into speech recognition system

(76) Inventors: Qingwei Zhao, Beijing (CN); Jielin Pan, Beijing (CN); Yonghong Yan, Beaverton, OR (US); Chunrong Lai, Beijing (CN)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/966,901

(22) Filed: Sep. 27, 2001

(51) Int. Cl. G10L 15/18

(52) U.S. Cl. 704/257

(57) ABSTRACT

A system is described for recognizing continuous speech based on M-gram language model. The system includes a lexical tree having a number of nodes, a buffer having a number of entries and a merging task to merge tokens to form a merged token list. The system decodes an input speech by propagating tokens along a number of different paths within the lexical tree. Each token contains information relating to a probability score and a word path history. The merging task is configured (1) to access a token list containing a group of tokens that have propagated to current state from a number of transition states, (2) to place tokens into an appropriate entry in the buffer according to a hash value and (3) to merge tokens with the same sequence of word candidates.

### BACKGROUND

1. Field of the Invention

The present invention generally relates to speech recognition, and in particular to a speech recognition system that has a language model integrated therein.

2. Description of the Related Art

Token propagation scheme was first proposed in “Token Passing: A Simple Conceptual Model for Connected Speech Recognition Systems” by S. J. Young, N. H. Russell and J. H. S. Thornton, Cambridge University Engineering Department 1989. Token propagation described by Young et al. relates a connected word recognition based on “token passing” within a transition network structure. In one implementation, the transition network structure is embodied in the form of a dictionary or a collection of words organized in a tree format, also referred to as a lexical tree, which can be reentered. In another implementation, the transition network structure is embodied in the form of a single word graph. In token propagation scheme, packets of information, known as tokens, may be propagated through the lexical tree. And during token propagation, potential word boundaries may be recorded in a linked list structure. Hence on completion at time T, the path identifier held in the token with the best score (or highest matching probability) can be used to trace back through the linked list to find the best matching word sequence and the corresponding word boundary locations.

To improve the accuracy of a continuous speech recognition system, a language model may be used to find the best word sequence from different word sequence alternatives. The language model is used to provide information relating to the probability of a particular word sequence of limited length. Language models may be classified as M-gram models, where M represents the number of words considered in the evaluation of a word sequence.

Language model information plays an important role in continuous speech recognition. Various ways exist for integrating M-gram language model (LM) in the tree decoder of a speech recognition system. Firstly, at time t, the LM-state dynamic programming optimization may be invoked for a token list at each state of the lexical tree, including middle states of the tree and at the leaf node of the tree. This kind of optimization merges all tokens that are equivalent with respect to their M-gram language model state in their path history, i.e., sharing the same last (M-1) words. Secondly, at time t, for tokens lying in leaf nodes of the tree, the M-gram probabilities are added into the token probability in terms of the word sequence in its word path history. Thirdly, at time t, for tokens laying in middle nodes of the tree, factored language model probabilities are employed in the beam pruning process, which is also referred to as a lookahead language model.

Various methods have been suggested for merging tokens with same path history. However, conventional methods of merging tokens suffer from various disadvantages. For example, most, if not all, of the conventional token merging processes employed by existing speech recognition systems become increasingly difficult to implement as M (i.e., the number of words considered in the evaluation of a word sequence) increases. Consequently, the conventional algorithms for merging tokens may only be suitable in those cases that merge tokens according to one or two previous words of path history. At least in one conventional token merging method, if (M-1) predecessor word history is to be employed for merging the tokens, then a buffer of size V^{m-1} is needed. This means that for a large vocabulary model (e.g., 60,000+), a buffer with over 3,600,000,000 entries is necessary to handle such vocabulary size in a tri-gram based model. Consequently, due to the finite size of buffer, it is difficult to integrate conventional methods of merging tokens to tri-gram or longer span based language models.

### BRIEF DESCRIPTION OF THE DRAWINGS

FIG. 1 is a block diagram of a large vocabulary continuous speech recognition system according to one embodiment of the invention.

FIG. 2 is a flowchart of merging tokens according to one embodiment of the invention.

FIG. 3 is an example of a token list before and after merging operation.

FIG. 4 is a flowchart of token propagation operation implemented by a speech recognition system according to one embodiment of the invention.

### DETAILED DESCRIPTION

In the following description, specific details are set forth in order to provide a thorough understanding of the present invention. However, it will be apparent to one skilled in the art that the present invention may be practiced without these specific details. In other instances, well-known circuits, structures and techniques have not been shown in detail in order to avoid obscuring the present invention.

In one embodiment, a system for recognizing continuous speech based on M-gram language model is described. The system utilizes a lexical tree having a number of nodes and recognizes an input speech by propagating tokens along a number of different paths with the lexical tree. Each token represents an active partial path which starts from the beginning of an utterance and ends at a time frame (t) and contains information relating to a probability score and a word path history. A merging task for merging tokens with the same word history is implemented by the continuous speech recognition system. In one embodiment, the merging task is configured (1) to access a token list containing a group of tokens that have propagated to current state from a number of transition states, (2) to place tokens into an appropriate entry in the buffer according to a hash value and (3) to merge tokens with the same sequence of word candidates. By doing so, the system according to one embodiment is capable of handling a long span M-gram language model integrated into a tree search process with high efficiency. As a result, the performance of the speech recognition system may be improved accordingly.

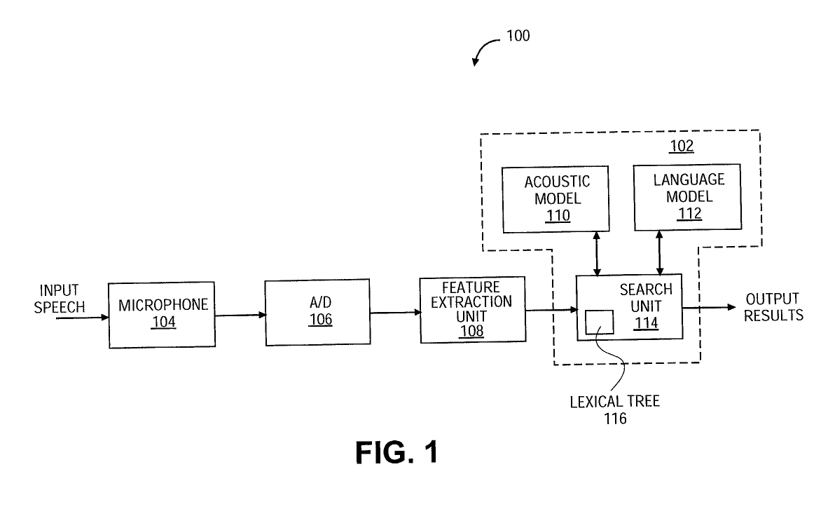

FIG. 1 depicts a large vocabulary continuous speech recognition system 100 according to one embodiment of the invention. The speech recognition system 100 includes a microphone 104, an analog-to-digital (A/D) converter 106, a feature extraction unit 108, a search unit 114, an acoustic model unit 110 and a language model unit 112. The microphone 104 receives input speech provided by a speaker and converts the audio signal to an analog signal. The A/D converter 106 receives the analog signals representative of the audio signals and transforms them into corresponding digital signals. The digital signals output by the A/D converter are processed by the feature extraction unit 108 to extract a set of parameters (e.g., feature vectors) associated with a segment (e.g., frame) of the digital signals. The sequence of vectors received from the feature extraction unit 108 is then analyzed by the search unit 114 in conjunction with the acoustic model unit 110 and language model unit 112.

The speech recognition system 100 is configured to recognize continuous speech based on probabilistic finite state sequence models known as Hidden Markov Models (HMMs). In this regard, the sequence of vectors representing the input speech is analyzed by the search unit 114 to identify a sequence of HMMs with the highest matching score.

In one embodiment, the lexicon utilized by the search unit 114 is organized in a tree format, shown as a lexical tree 116 in FIG. 1. The lexical tree 116 includes a number of nodes. Each node in the tree is associated with a triphone HMM model, in which each HMM model is composed of some states. Because spoken utterance to be recognized may be expressed in terms of a number of different paths propagated along the lexical tree with different probability scores, a large number of sequences of word candidates linked in a number of different ways may be produced.

The search unit 114 implements a search algorithm based on a token propagation scheme. In a token propagation scheme, packets of information, known as tokens, are passed through a transition network configured to represent search paths for decoding the input speech. A token refers to an active partial path which starts from the beginning of an utterance and ends at time t. Each token contains information relating to the partial path traveled (referred hereinafter as a “word path history”) and an accumulated score (referred hereinafter as a “probability score”) indicative of the degree of similarity between the input speech and the portion of the network processed thus far.

In one embodiment, the language model 112 integrated in the speech recognition system 100 is a long span M-gram language model (LM), such as a tri-gram or longer span LM. The language model 112 may be invoked at various stages of the speech recognition process. For example, LM-state dynamic programming optimization may be invoked for a token list at each state of the lexical tree, including middle states of the tree and at the leaf node of the tree. During LM-state dynamic programming optimization, all tokens that are equivalent with respect to their M-gram language model state in their path history (i.e., sharing the same last (M-1) words) are merged together.

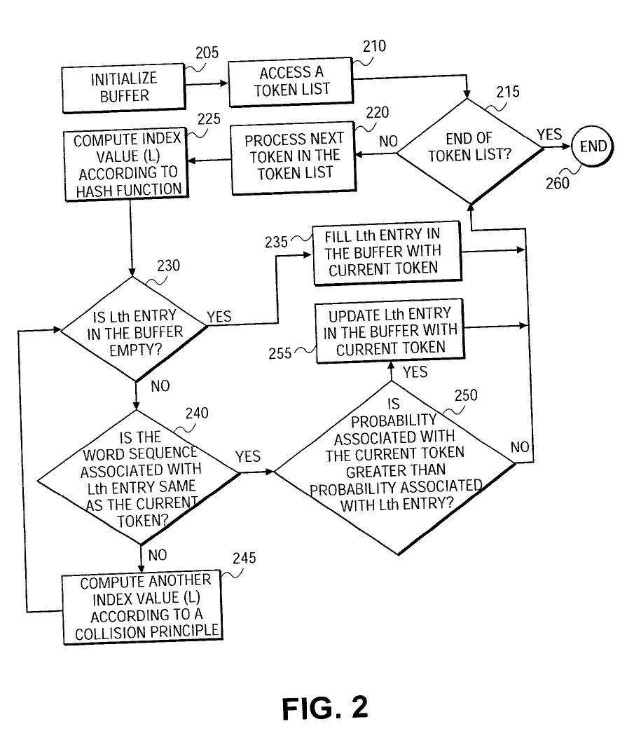

To merge tokens in a token list, the search unit 114 is configured to implement a merging task which will be discussed more in detail with reference to FIG. 2. According to one aspect of the one embodiment, the merging task merges tokens based on a hash function to effectively employ long span M-gram language models. In operation, the merging task first accesses a token list containing a group of tokens that have propagated to current state from a plurality of transition states. Then, the merging task calculates a hash value for each token in the token list based on its word path history and merges tokens according to the hash value. Advantageously, by doing so, a buffer having a moderate size may be used to contain tokens during the merging operation. More specifically, the tokens are merged by placing tokens into an appropriate entry in the buffer according to the hash value and if the entry in the buffer associated with the hash value is occupied, the merging task then determines if the word path history associated with the token residing therein matches the word path history associated with a current token. If the word path history of the preexisting token and the current token are the same, the merging task retains one of the tokens with the higher probability score and removes the other token from the token list.

FIG. 2 depicts operations of the merging task to merge tokens according to one embodiment of the invention. During the merging operation, the merging task identifies from an initial set of token list one or more tokens having the same word indexes and merges the tokens with the same word indexes to form a merged set of token list.

In block 205, a buffer having a number of entries is initialized. Each entry in the buffer is capable of containing one token. In one embodiment, each entry in the buffer is indexed according to a hash value. Accordingly, during the merging operation, each token is placed into an appropriate entry in the buffer according to a hash value computed based on its word path history. The hash value associated with a token is obtained by applying a hash function to a sequence of predecessor words, i.e., its word path history.

In block 210, the merging task accesses a token list containing a group of tokens. A token list refers to a group of tokens that can propagate to current state S from all possible transition states. The tokens contained within the same token list differ either in their path score or in their path history and are generated in the search module based on a token propagation algorithm. In this regard, each token in the token list includes, among other things, two elements, namely, a path identifier (i.e., word path history) and a probability score.

Once a token list has been accessed, the merging task proceeds to a main-loop (blocks 215-255) to process each token individually. Each token in the token list is examined until the end of the token list has been reached (block 215, yes) and terminates in block 260. The main-loop works its way through the group of tokens by processing the next token in the list in a sequential manner (block 220). Then in block 225, an index value associated with the current token is computed according to a hash function applied to a sequence of predecessor words associated with the current token.

In one embodiment, the index value of a token having a particular sequence of predecessor words is computed as follows:

L=α(1)W(1)+α(2)W(2)+α(3)W(3) (1)

where L represents an index value associated with a token based on its word path history;

W(1) represents a word index number associated with the first word in the word path history;

W(2) represents a word index number associated with the second word in the word path history;

W(3) represents a word index number associated with the third word in the word path history; and

α(1), α(2), α(3) are individually assigned to a constant number (e.g., small integer value such as 1, 2, 3 etc).

It should be noted that other algorithms may be used to compute index value associated with a particular token based on its word path history.

W(1), W(2), W(3) each represents an index number which is used to identify a particular word in the dictionary corresponding with one of the words associated with the current token's word path history. For example, if the dictionary used by the speech recognition system contains 60,000 words, W(1)-W(3) will contain an integer value ranging from 1 to 60,000.

In block 230, the merging task determines if the entry associated with the computed index value (L) in the buffer is empty. If the entry is empty (block 230, yes), it is filled with the current token (block 235). A token may be represented by a data structure containing word path history information and probability score information and a pointer may be used to point to that data structure. In one embodiment, the merging task load the pointer associated with the current token into the buffer entry associated with the computed index value in block 235. Accordingly, the pointer may be used to obtain all the necessary information with regard to the token residing in a particular buffer entry.

If the entry associated with the computed index value (L) is not empty (block 230, no), the merging task determines if the word path history, i.e., W(1), W(2) and W(3), associated with the token residing in the L^{th} entry is the same as the current token (block 240). This may be accomplished by comparing the word index numbers W(1), W(2) and W(3) associated with the current token with index numbers associated with the token residing in the L^{th} entry. In one embodiment, the index numbers W(1), W(2), W(3) associated with the word path history of a token are included in its data structure.

If the word path history associated with the L^{th} token and the current token is the same (block 240, yes), this means these tokens have the same word path history and will be merged by retaining the token with the highest score and removing the other token from the token list. Accordingly, in block 250, the merging task determines if the probability score associated with the current token is greater than the probability score associated with the token residing in the L^{th} entry. If the current token has higher probability score (block 250, yes), the L^{th} entry in the buffer is updated with the pointer associated with the current token (block 255). Otherwise (block 250, no), the token residing in the L^{th} entry remains there and the current token is discarded.

In the event the word path history associated with the token residing in the L^{th} entry does not match the word path history associated with the current token (block 240, no), the merging task proceeds to block 245 where a new index value is computed for the current token according to a collision principle.

In one embodiment, the new index value for the current token is computed as follows:

L_{new}=[L_{old}−D]mod(TW) (2)

where L_{new} represents a new index value associated with the current token based on collision principle;

L_{old} represents a previously computed index value associated with the current token;

D represents a constant number; and

TW represents the total number of words contained in the dictionary utilized by the speech recognition system.

Alternatively, other algorithms may be used to compute a new index value. For example, algorithms such as L_{new}=[L_{old}+D]mod(TW) and L_{new}=[L_{old}+2D]mod(TW) also guarantee that the merging task will go through the hash table or the buffer in a proper order. In one implementation, D can be any prime number (e.g., 2, 3, 7, etc) not divisible by TW and can be adjusted according to the complexity of the task. In one embodiment, because the new index value is computed based on a collision principle, this ensures that a subsequent token with the same word path history will go through the hash table in a proper order and be assigned to the same new index number.

For the purpose of illustration, assume that α(1), α(2) and α(3) are all set to one and that during the merging operation, a token having a word path history of W(1), W(2) and W(3) equal to 100, 200 and 300, respectively, is encountered. In this case, the index value associated with such token will be 600 according to the first algorithm (1) provided above. Then, some time later, another token is encountered with a word path history of W(1), W(2) and W(3) equal to 200, 300 and 100, respectively which also produces an index value of 600 according to the first algorithm (1). Since the 600^{th} entry in the buffer is already occupied by the previous token, a new index number is generated according to the second algorithm (2) provided above. If we assume that D is set to seven and TW is 60,000, the new index value will equal 593 (i.e., L_{new} =[600−7]mod(60,000)). It is likely that the entry in the buffer corresponding to the new index value is null. However, if the buffer entry associated with the new index number L_{new} is not empty, the merging task will continue through the sub-loop (blocks 230-240-245) until an empty entry has been identified.

Although in the illustrated embodiment three words W(1), W(2) and W(3) are associated with the word path history, it should be noted that the merging task of the invention may be used to merge tokens with other word path history length (e.g., 4, 5, 6, etc).

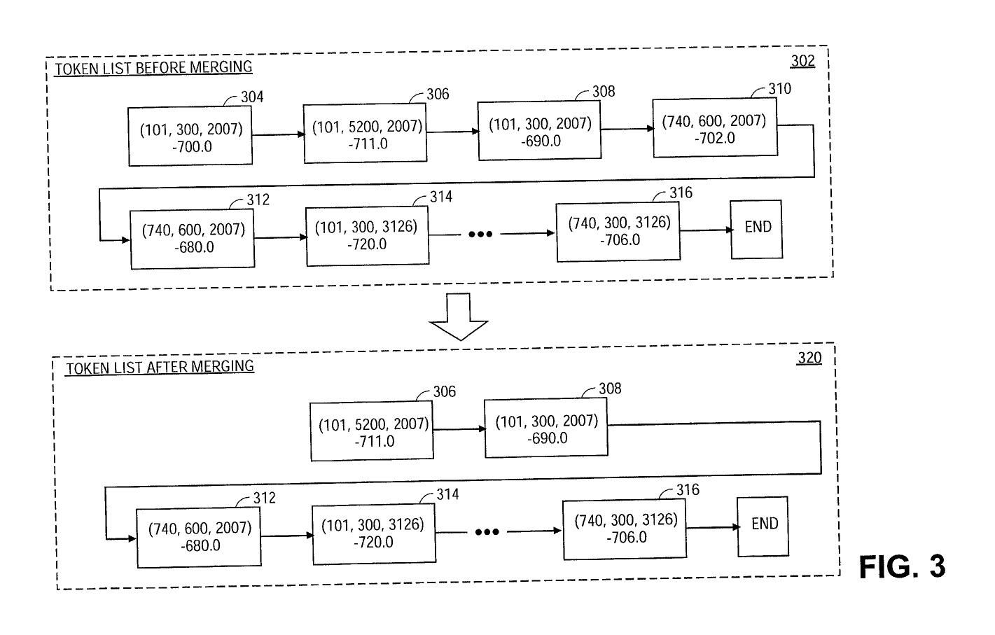

FIG. 3 depicts an example a token list 302 before merging operation and a token list 320 after the merging operation. In one embodiment, tokens which have the same word path history are merged together. As discussed above, if there are two or more tokens with the same word path history, the token with the highest score is retained and other tokens are removed from the token list. In the illustrated example, tokens 304 and 308 have the same word path history (101, 300, 2007), so they are merged and the token 308 with the higher probability score (−690.0) is kept. As seen by referring to block 320 of FIG. 3, the token 304 is removed from the token list after merging. Similarly, tokens 310 and 312 have the same word path history (740, 600, 2007), so they are also merged and the token 312 with the higher probability score (−680.0) is kept.

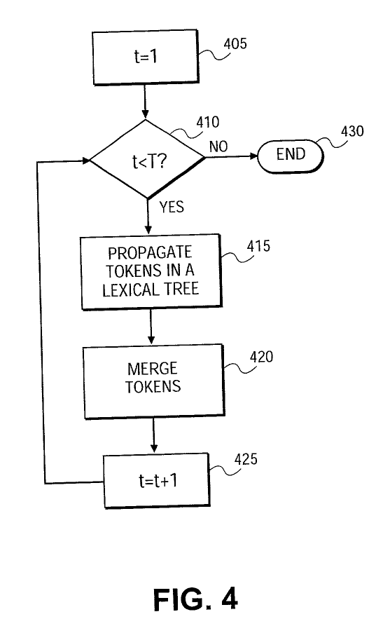

FIG. 4 depicts token propagation operation implemented by a speech recognition system according to one embodiment of the invention. The token propagation operation begins at block 405, where the frame counter (t) is initialized; i.e., the frame counter (t) is set to one. At this point, the token propagation operation proceeds in a loop (blocks 410-425) to decode input speech. Each token in the lexical tree represents an active partial path which starts from the beginning of an utterance and ends at the current time (t). The loop (blocks 410-425) works its way through the input speech which is represented by a number of frames. At each time frame (t), the tokens in each state of each node in the lexical tree are propagated to its following states according to transition rules (block 415). Then in block 420, the tokens in each state are merged together based on their word path history according to the merging operation discussed above. Then in block 425, the frame counter (t) is incremented by one and proceeds to the next time frame. The loop (blocks 410-425) is continued until end of the input speech (T) is reached (block 410, no) and terminates in block 430.

A number of advantages may be achieved by the merging operation of the invention. First, the merging task of the invention is capable of handling a token list with relatively large number of tokens. Second, the merging task of the invention is capable of handling a long span M-gram language model, including models in which the number of words considered in the evaluation of a word sequence is three or greater. This means that a long-span M-gram language model (where M>=3) can be integrated into the tree search process with high efficiency. As a result, the performance of the speech recognition system can be improved accordingly.

The operations performed by the present invention may be embodied in the form of software program stored on a machine-readable medium, such as, but is not limited to, any type of disk including floppy disks, hard disks, optical discs, CD-ROMs, and magneto-optical disks, read-only memories (ROMs), random access memories (RAMs), EPROMs, EEPROMs, magnetic or optical cards, or any type of media suitable for storing electronic instructions representing the software program. Moreover, the present invention is not described with reference to any particular programming language. It will be appreciated that a variety of programming languages may be used to implement the teachings of the invention as described herein.

While the foregoing embodiments of the invention have been described and shown, it is understood that variations and modifications, such as those suggested and others within the spirit and scope of the invention, may occur to those skilled in the art to which the invention pertains. The scope of the present invention accordingly is to be defined as set forth in the appended claims.

What is claimed is:

1. A system comprising:
a lexical tree having a plurality of nodes, wherein an input speech is processed by propagating tokens along a plurality of different paths within the lexical tree, each token containing information relating to a probability score and a word path history;
a buffer having a plurality of entries; and
a merging task (1) to access a token list containing a group of tokens that have propagated to current state from a plurality of transition states, (2) to place tokens into an appropriate entry in said buffer according to a hash value and (3) to merge tokens with the same word path history to form a merged token list.

2. The system of claim 1, further comprising a long-span M-gram language model integrated into the system.

3. The system of claim 2, wherein said long-span language model is a tri-gram based language model.

4. The system of claim 2, wherein said M is greater than three.

5. The system of claim 1, wherein said hash value of a token is computed based on a word path history associated with said token.

6. The system of claim 5, wherein said hash value associated with a particular token is calculated as follows:
L=α(1)W(1)+α(2)W(2)+α(3)W(3)
where W(1) represents a word index number associated with the first word in the word path history;
W(2) represents a word index number associated with the second word in the word path history;
W(3) represents a word index number associated with the third word in the word path history; and
α(1), α(2), α(3) are individually assigned to a constant number.

7. The system of claim 1, wherein said merging task calculates a new hash value for a token in the event the buffer entry associated with the previous hash value contains another token with different word path history.

8. A method comprising:
passing tokens through a transition network configured to represent search paths for decoding an input speech;
accessing a token list containing a group of tokens that have propagated to current state from a plurality of transition states, each token in the token list containing information relating to a word path history and a probability score;
calculating a hash value for each token in said token list; and
merging tokens with same word path history according to said hash value.

9. The method of claim 8, further comprising integrating long-span M-gram language model in a speech recognition system.

10. The method of claim 8, wherein said long-span language model is a tri-gram based language model.

11. The method of claim 8, wherein said hash value of a particular token is computed based on said word path history associated with said token.

12. The method of claim 8, wherein said merging tokens comprises:
placing tokens into an appropriate entry in a buffer according to said hash value;
if the entry in the buffer associated with said hash value is occupied, determining if a word path history associated with the token residing therein matches a word path history associated with a current token; and
if the word path history of the preexisting token and the current token are the same, retaining one of the tokens with the higher probability score and discarding the other token.

13. The method of claim 8, further comprising computing a new hash value for a token in the event the buffer entry associated with the previous hash value is occupied by another token with different word path history.

14. The method of claim 13, wherein said new hash value is computed based on a collision principle to ensure that a subsequent token with the same word path history will go through the hash table in a proper order and be assigned to the same new index number.

15. A machine-readable medium that provides instructions, which when executed by a processor cause said processor to perform operations comprising:
accessing a token list containing a group of tokens that have propagated to current state from a plurality of transition states, each token in the token list containing information relating to a word path history and a probability score;
calculating a hash value for each token in said token list; and
merging tokens with same word path history according to said hash value.

16. The machine-readable medium of claim 15, wherein said hash value of a particular token is computed based on said word path history associated with said token.

17. The machine-readable medium of claim 15, wherein said operation of merging tokens comprises:
placing tokens into an appropriate entry in a buffer according to said hash value;
if the entry in the buffer associated with said hash value is occupied, determining if a word path history associated with the token residing therein matches a word path history associated with a current token; and
if the word path history of the preexisting token and the current token are the same, retaining one of the tokens with the higher probability score and discarding the other token.

18. The machine-readable medium of claim 15, wherein said operation further comprises computing a new hash value for a token in the event the buffer entry associated with the previous hash value is occupied by another token with different word path history.

19. The machine-readable medium of claim 18, wherein said new hash value is computed based on a collision principle to ensure that a subsequent token with the same word path history will go through the hash table in a proper order and be assigned to the same new index number.
